(19) United States
(12) Patent Application Publication
(10) Pub. No.: US 2026/0192179 A1
(43) Pub. Date: Jul. 9, 2026

(54) Competitive Scoring Platform

(71) Applicant: Louis A. Venezia, Boynton Beach, FL (US)

(72) Inventor: Louis A. Venezia, Boynton Beach, FL (US)

(21) Appl. No.: 19/443,217

(22) Filed: Jan. 8, 2026

Related U.S. Application Data
(60) Provisional application No. 63/743,201, filed on Jan. 8, 2025.

(51) Int. Cl. A63B 71/06; G06F 17/18

(52) U.S. Cl. CPC A63B 71/0669; A63B 71/0616; G06F 17/18

(57) ABSTRACT

The present disclosure provides for a competitive scoring platform that allows for user judges to score competitive events. User judges may include amateurs, professional judges in training, or casual spectators. User judge scores may be compared actual judge scores and provide accuracy results. A competitive scoring platform may include a social media platform component, allowing for user judge friends to compete and compare their scoring capabilities. The competitive scoring platform may directly stream competitive events live or in a rebroadcast, which may allow for real time or asynchronous user judge scoring.

### CROSS-REFERENCE TO RELATED APPLICATION

This application claims priority to and the full benefit of U.S. Provisional Patent Application Ser. No. 63/743,201 (filed Jan. 8, 2025, and titled “COMPETITIVE SCORING PLATFORM”), the entire contents of which are incorporated in this application by reference.

### BACKGROUND

Traditionally, competitive events such as surfing, gymnastics, boxing, or figure skating are adjudicated by a select panel of official judges located at the venue. Spectators, whether present at the venue or viewing remotely through television or internet broadcasts, typically consume the event passively. The official judges observe a competitor's performance and render scores based on established criteria, which are then aggregated and displayed to the audience via the broadcast feed or a scoreboard. The audience receives the final result as a static data point after the performance has concluded.

However, this passive consumption model limits spectator engagement with the sport. While viewers often form their own subjective opinions regarding a competitor's performance, they lack a dedicated technical platform to record their assessments in real-time or objectively validate their judgment against the official panel. Furthermore, because broadcast graphics often reveal official scores immediately, a viewer's ability to generate an unbiased assessment is frequently compromised by the premature exposure to the official results. Consequently, there is a lack of integrated systems that allow for amateur judges, professional judges in training, or casual spectators to actively participate in the scoring process and accurately quantify their scoring proficiency relative to official standards.

### SUMMARY OF THE DISCLOSURE

What is needed is a competitive event scoring system including a cloud-based server configured to communicate with a plurality of user devices over a network. The present disclosure provides a competitive event scoring system including a cloud-based server configured to communicate with a plurality of user devices over a network. The system includes a synchronization module executed by the cloud-based server and configured to establish a real-time data connection with an external broadcast system transmitting a live competitive event. This module receives official judge score data, which includes a plurality of official scores assigned to a competitor, and timestamp data indicating when the official judge score data becomes available. A user interface module transmits competitive event video data to a user device for display and receives a user judge score assigned to the competitor by a user judge. This module selectively transmits the official judge score data to the user device based on the timestamp data, ensuring the official judge score data is obscured from display until the timestamp data indicates availability.

The system further includes a score comparison module configured to calculate a score differential value between the user judge score and the plurality of official scores. It generates and transmits a color-coded visual indicator representing the degree of accuracy of the user judge score relative to the official scores. A storage module stores historical scoring data, including user scores across multiple events and official score sets. The score comparison module calculates a cumulative accuracy metric for the user judge based on this historical data.

In some embodiments, the synchronization module receives competitor statistics data, such as competitor name, group classification, performance difficulty metrics, or objective measurements, which are displayed concurrently with the video data. This data may be generated by an artificial intelligence image analysis component that processes the video to extract visual performance data. The system may block the reception of user judge score data after the official scores become available. The score comparison module may be configured to discard a highest and lowest official score to generate a filtered set for calculation and display a visual indication of the discarded scores.

In some embodiments, a social platform module that pairs a user judge with a friend user judge, receives friend scores, calculates friend score differentials, and displays these alongside the user's score. A leaderboard module may aggregate cumulative accuracy metrics to rank user judges and identify professional judges in training based on a training status indicator. A training module may provide scoring courses, track completion, and unlock advanced courses based on accuracy metrics exceeding a threshold.

The present disclosure also describes a system for quantifying user scoring performance in a competitive event environment. This system includes processors and instructions to generate a competitive scoring interface displaying a video stream of a competitor. The system receives a user judge score and a set of actual judge scores from an external server associated with a live broadcasting entity. A comparator algorithm executes to calculate a score accuracy metric representing a numerical deviation between the user score and the actual scores. A dynamic leaderboard interface is generated to display a ranking of user judges based on these metrics.

In specific implementations, calculating the accuracy metric involves discarding the highest and lowest scores from a set of five distinct scores. The system may update the leaderboard to display a visual indicator identifying a user as a professional judge in training if a threshold is met. It may also monitor user history to unlock specific achievements on a user profile. Furthermore, the system may display competitor statistics derived from artificial intelligence (AI) image analysis to validate the user judge score.

The present disclosure further provides a computer-implemented method for managing unbiased user interaction with a live competitive event. The method includes streaming a broadcast of a competitive event while substantially simultaneously receiving a data packet containing a set of actual judge scores from a remote server. The user interface is rendered in a blind scoring state, which includes a user input mechanism and a results region where the actual judge scores are maintained in a concealed format preventing visual identification. Upon detecting an input of the user score, the interface automatically transitions from the blind scoring state to a revealed state, rendering the actual judge scores in a visible format.

In some aspects, the method includes disabling the user input mechanism after transitioning to the revealed state. Maintaining the concealed format may involve applying a graphical obscuration layer that is removed upon the transition. The method may further include displaying a visual comparison graphic indicating variance immediately upon transitioning to the revealed state. The user input mechanism may be enabled only after receiving a synchronization signal indicating the conclusion of a performance. Additionally, the method may include displaying a validated set of anticipated competitor statistics, such as wave height, wave difficulty, or maneuver difficulty, prior to detecting the user score input to provide context.

A number of embodiments of the present disclosure will be described. While this specification contains many specific implementation details, these should not be construed as limitations on the scope of any disclosures or of what may be claimed, but rather as descriptions of features specific to particular embodiments of the present disclosure. It is understood to those skilled in the art that variations, modifications, and alterations may be apparent. It will be understood that various modifications may be made without departing from the spirit and scope of the disclosure.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1 illustrates an exemplary competitive scoring platform GUI for a desktop, according to some embodiments of the present disclosure.

FIG. 2A illustrates an exemplary competitive scoring platform GUI for a handheld device, according to some embodiments of the present disclosure.

FIG. 2B illustrates an exemplary competitive scoring platform GUI for a handheld device, according to some embodiments of the present disclosure.

FIG. 3 illustrates an exemplary competitive scoring platform GUI for a handheld device, according to some embodiments of the present disclosure.

FIG. 4 illustrates an exemplary competitive scoring platform GUI for a handheld device, according to some embodiments of the present disclosure.

FIG. 5A illustrates an exemplary competitive scoring platform GUI for a handheld device, according to some embodiments of the present disclosure.

FIG. 5B illustrates an exemplary competitive scoring platform GUI for a handheld device, according to some embodiments of the present disclosure.

FIG. 6 illustrates an exemplary competitive scoring platform GUI for a handheld device, according to some embodiments of the present disclosure.

FIG. 7 illustrates an exemplary competitive scoring platform GUI for a handheld device, according to some embodiments of the present disclosure.

FIG. 8 illustrates an exemplary competitive scoring platform GUI for a handheld device, according to some embodiments of the present disclosure.

FIG. 9 illustrates an exemplary competitive scoring platform GUI for a handheld device, according to some embodiments of the present disclosure.

FIG. 10 illustrates an exemplary competitive scoring platform GUI for a handheld device, according to some embodiments of the present disclosure.

The Figures are not necessarily drawn to scale, as their dimensions can be varied considerably without departing from the scope of the present disclosure.

### DETAILED DESCRIPTION

The present disclosure provides generally for a competitive scoring platform that allows for user judges to score competitive events. According to the present disclosure, the platform may allow for individuals who are amateur judges, professional judges in training, or casual spectators to score competitive events and compare them to the actual scores from the official judges.

In the following sections, detailed descriptions of examples and methods of the disclosure will be given. The description of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Competitive Scoring Platform: as used herein refers to the functionality of a software application to review, judge, and score competitive events on a cloud-based application.

In some aspects, the competitive scoring platform may include a user interface, wherein the user interface may be configured to help a user navigate and use the competitive scoring platform.

User Judge: as used herein refers to any individual that uses the competitive scoring platform, wherein the user judge interacts with the competitive scoring platform to review, judge, and score competitive events.

Score: as used herein refers to the objective values assigned to a competitive event by a user judge based on their review of the competitor's performance during the competitive event. In some aspects, the score may be based on performance, difficulty, skill, speed, and efficiency, as non-limiting examples.

Competitive Event: as used herein refers to the subject of review available on the competitive scoring platform, wherein the competitive scoring platform may list or display at least one competitive event that a user judge may interact with. In some aspects, the competitive event may be a sporting or entertainment event. By way of example and not limitation, the competitive event may be a surfing event, a gymnastics event, boxing event, or a musical event.

Competitor: as used herein refers to the individual or team competing in a competitive event, wherein the user judge may review, score, and judge the performance of the individual or team.

Interactive Technology or Application: as used herein refers to the proprietary software platform which enables users to engage, interact, and participate in real-time with live sporting events. The Application facilitates access to live data feeds, multimedia content, audience interaction features, and other event-related digital experiences.

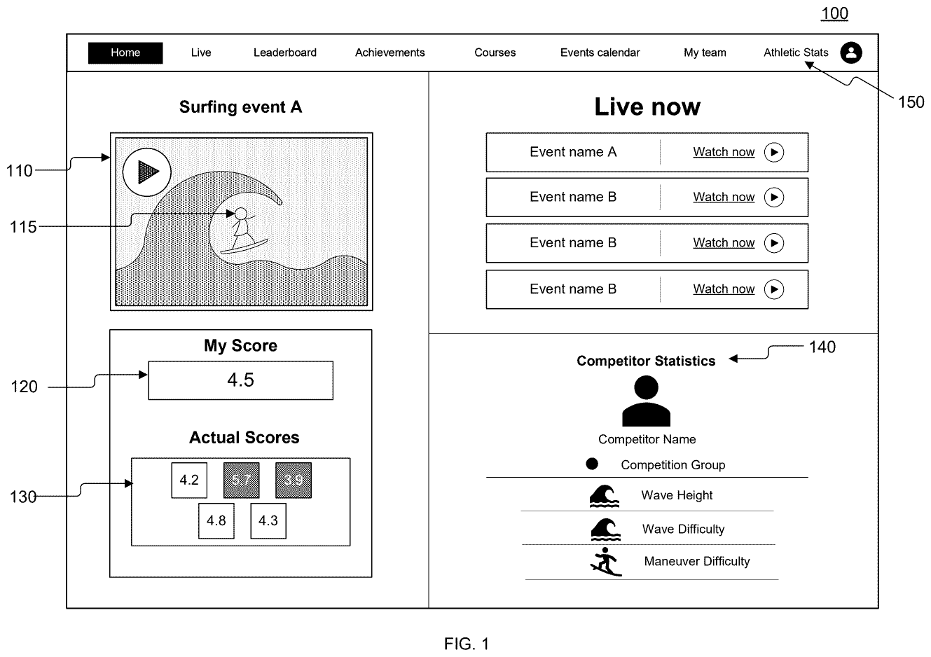

Referring now to FIG. 1, an exemplary competitive scoring platform 100 GUI for a desktop, according to some embodiments of the present disclosure, is illustrated. In some aspects, a user may be able to view a competitive event 110 through the desktop, such as through streaming, which may be live or recorded. A user judge may watch the competitor 115 in the sport and provide a user judge score 120. The user judge may then compare their user judge score 120 to the actual judge scores. The user judge may view competitor statistics 140 to understand the score and comparison.

As an illustrative example, the competitive event 110 may be a surf competition, which is scored based on many factors, including wave height, wave difficulty, and maneuver difficulty. The objective factors may be provided in the competitor statistics 140, including their name and competition group, such as professional or amateur. This may require an interface between live broadcasting and an external server configured to analyze the details of the competitor statistics 140. In some aspects, the analysis may occur through an AI image analysis of the competitive event 110 and the competitor 115. In some embodiments, the external server may receive actual judge assessments in real time from the live broadcasting entity, such as a league, broadcast channel, or sporting body. Further, a competitive event may includes five judges where the highest and lowest scores are discarded for the final score. The user judge score 120 may be compared to all five actual judge scores 130, allowing for a deeper understanding of the comparison.

In some embodiments, the competitive scoring platform may include an athletic stats tab 150. In some aspects, the athletic stats tab 150 may include an overview of statistics from a variety of competitors, such as professional or amateur, as non-limiting examples. By way of example and not limitation, the athletic stats tab 150 may provide the a historical record of user judge scores 120, competitor statistics 140, and any other competitive statistic specific to a competitor. In some aspects, the athletic stats tab 150 may include statistics regarding anyone who has participated in a competitive event included on the competitive scoring platform.

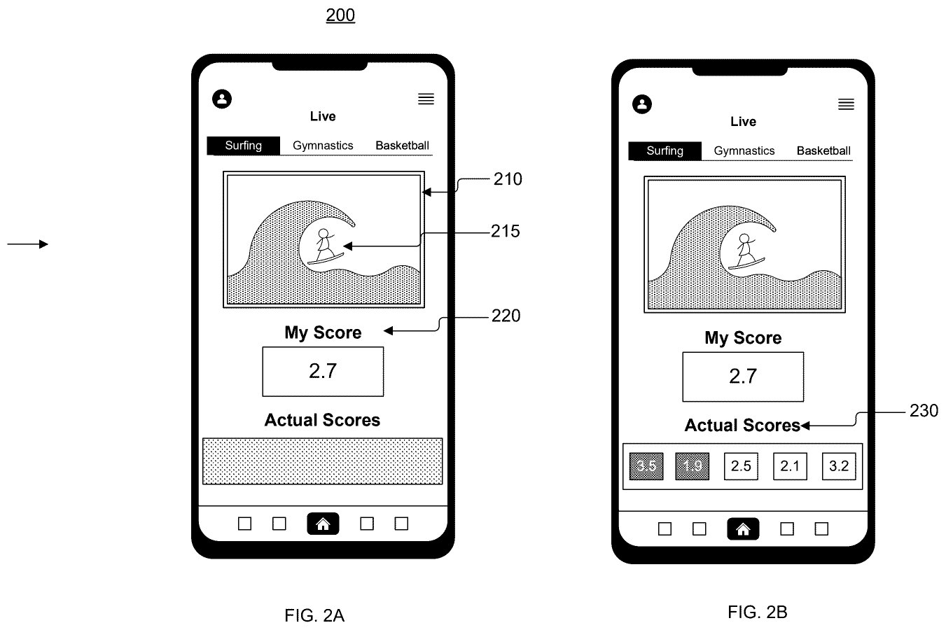

Referring now to FIG. 2A, an exemplary competitive scoring platform 200 GUI for a portable device, such as a cell phone or tablet, according to some embodiments of the present disclosure, is illustrated. In some aspects, a user judge may be able to view a competitive event 210 on their portable device and judge the competitor 215 during their run, match, heat, or other type of event section. In some embodiments, a user judge may input their user judge score 220 prior to viewing actual judge scores, which may be obscured. This may be because the user judge is scoring prior to the release of the actual judge scores or to increase the sense of competition and excitement for the user judge.

Referring now to FIG. 2B, an exemplary competitive scoring platform 200 GUI for a portable device, according to some embodiments of the present disclosure, is illustrated. In some implementations, once a user judge inputs their user judge score 220, the actual judge scores 230 may be revealed. This may allow for an unbiased scoring by the user judge without influence of what the actual judges score the competitive event 210. In some aspects, a user judge may be able to toggle between competitive event types, such as between sports, events, or competitor category, such as amateur or professional. In some aspects, a competitive scoring platform 200 may directly sync to a live broadcast of a competitive event 210, allowing for real time comparisons. The user judge scoring 220 may be blocked once the actual judge scoring 230 may be available.

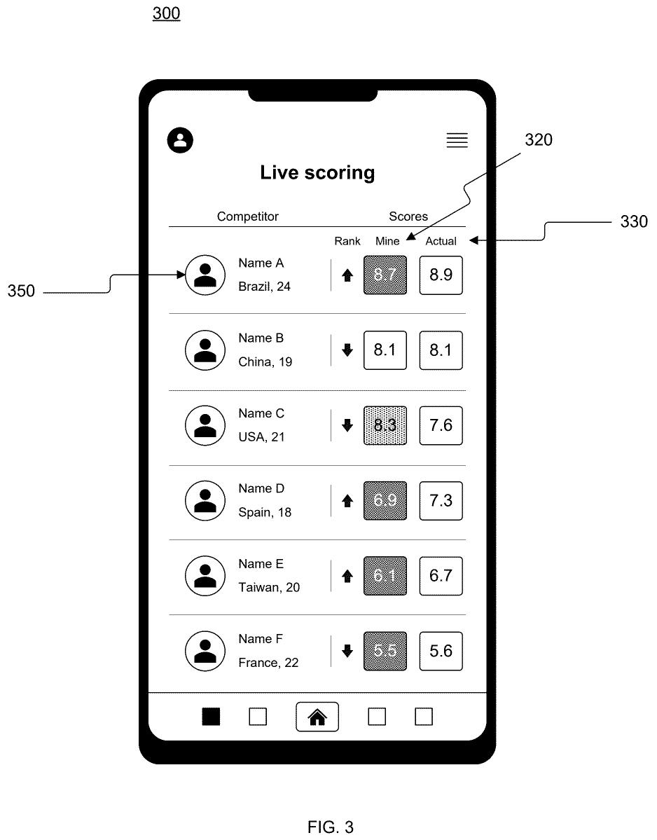

Referring now to FIG. 3, an exemplary competitive scoring platform 300 GUI for a portable device, according to some embodiments of the present disclosure, is illustrated. In some embodiments, user judge scores 320 may be directly compared to actual judge scores 330 in an interface that may list the scores by competitor 315. This may allow a user judge to view their scoring comparisons and capabilities at a broader level. In some aspects, the scores 310, 320 may be color coded, such as to indicate how close the user judge score 310 may be to an actual judge score 330 or whether the user judge score 320 was high or low.

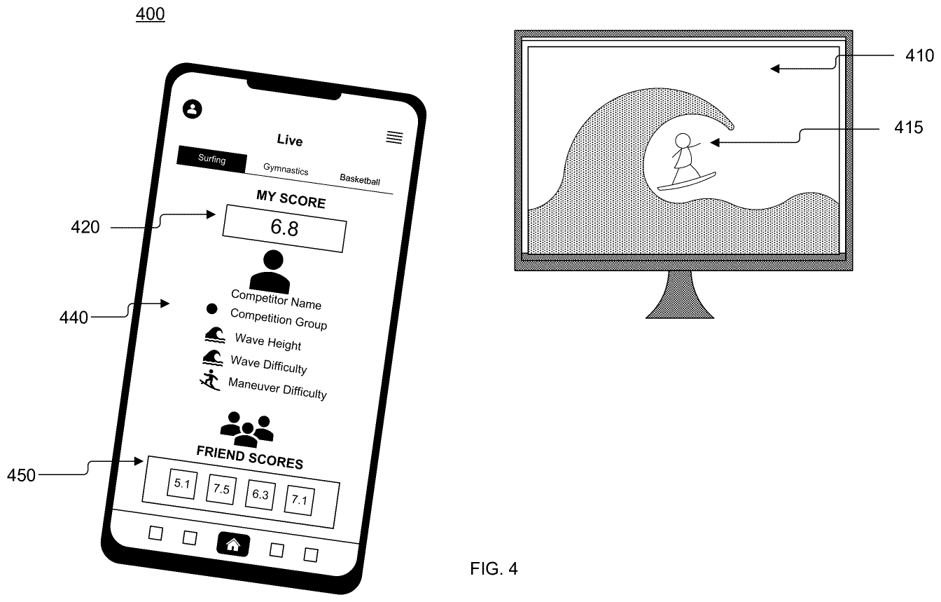

Referring now to FIG. 4, an exemplary competitive scoring platform 400 GUI for a portable device, according to some embodiments of the present disclosure, is illustrated. In some implementations, a user judge may want to compete with their friends during a competitive event 410 and be able to compare their assessment of the competitor 415. This may add another level of competition to the scoring process. In some embodiments, the competitive scoring platform 400 may be separate from the broadcast of the competitive event 410, which may require the competitive scoring platform 40 to sync with the broadcast system in real time, allowing for live user judge scoring 420.

In some aspects, a user judge may be able to input anticipated competitor statistics 440, which may validate the reason for the user judge score 420. These anticipated competitor statistics 440 may be compared to actual to explain to the user judge why there is a difference in score. The competitive scoring platform 400 may allow a user judge to pair with one or more friends, allowing for shared scoring visibility. User judge scores 420 may be viewed with friend user judge scores 450. This may allow for a sense of community and provide a social platform to interact with other user judges.

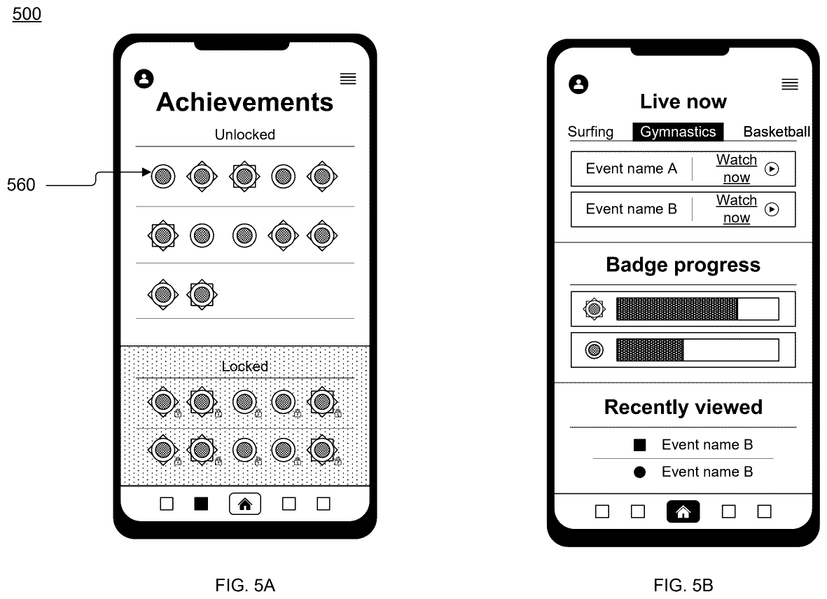

Referring now to FIGS. 5A-5B, an exemplary competitive scoring platform 500 GUI for a desktop, according to some embodiments of the present disclosure, is illustrated. In some aspects, a user judge may be able to unlock achievements 560 based on one or more factors. For example, a user judge may be able to track how many competitive events they have scored. A user judge may be able to track how many of their user judge scores have matched actual judge scores. As another example, a user judge may be able to track how many different types of competitive events they have scored. In some aspects, a user judge may be able to toggle between achievements for different sports or categories of competitive events. This may allow a user judge to have an understanding of how well they score different types of competitive events.

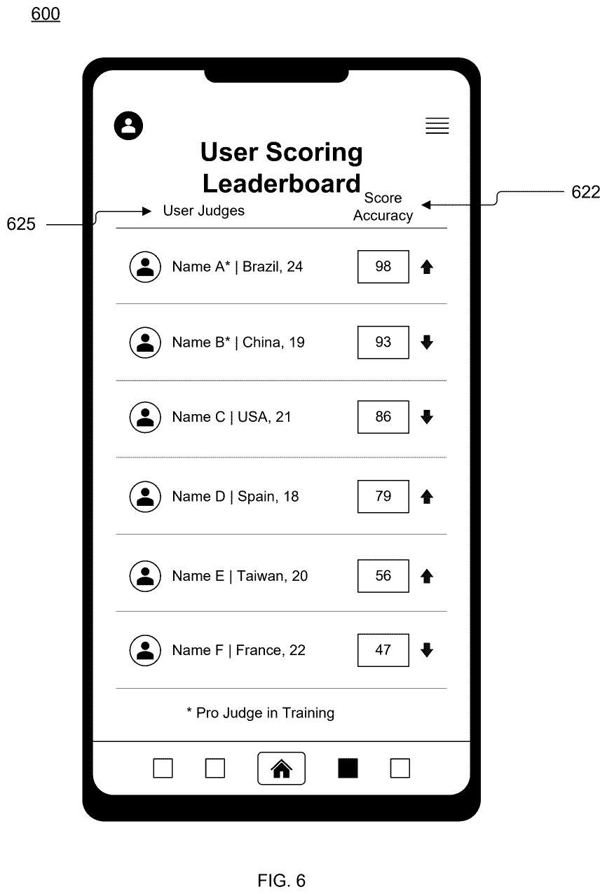

Referring now to FIG. 6, an exemplary competitive scoring platform 600 GUI for a portable device, according to some embodiments of the present disclosure, is illustrated. In some implementations, a leaderboard may show the ranking of different user judges based on their scoring results and comparisons. User judges 625 may be listed with their user judge score accuracy 622. The user judge score accuracy 622 may be delineated based on competitive event, competition types, or other groupings that may provide insight as to how well a user judge 625 scores event competitions.

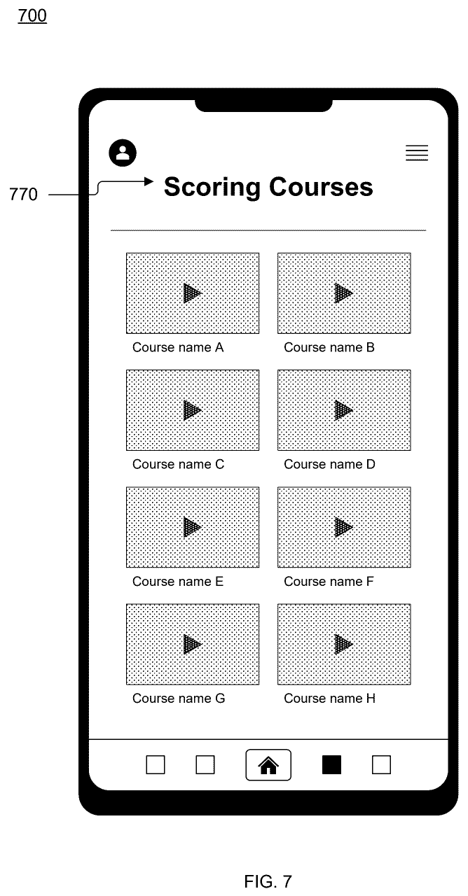

In some embodiments, a competitive scoring platform 600 may allow for a user judge to train to be a professional judge, such as illustrated in FIG. 7. When showing rankings, the competitive scoring platform 600 may indicate whether a user judge is in training. This may allow for a more insightful comparison between casual user judges and more serious user judges.

Referring now to FIG. 7, an exemplary competitive scoring platform 700 GUI for a portable device, according to some embodiments of the present disclosure, is illustrated. In some aspects, a competitive scoring platform 700 may provide scoring courses 770 to allow a user judge to become more proficient in scoring competitive events. As an example, the scoring courses 770 may be provided by an organizer or league of the competitive event. As another illustrative example, professional judges may provide scoring courses 770 to allow casual user judges or professional user judges in training to understand the scoring process better. The scoring courses 770 may be included in the competitive scoring platform 700, may be unlocked based on achievements, such as illustrated in FIG. 6, or may be paid for.

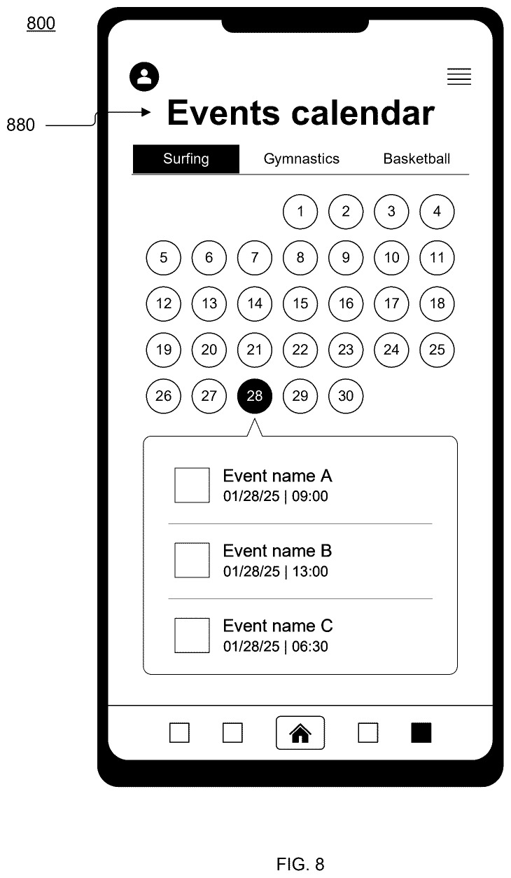

Referring now to FIG. 8, an exemplary competitive scoring platform 800 GUI for a portable device, according to some embodiments of the present disclosure, is illustrated. In some aspects, a competitive scoring platform 800 may provide an events calendar 880, allowing a user judge to select which competitive events they want to score. Selecting events in the events calendar 880 may unlock broadcast of the competitive event for the user judge. In some implementations, unlocking broadcasts may require payment or logging into a separate streaming channel. A user judge may be able to toggle between competitive event types.

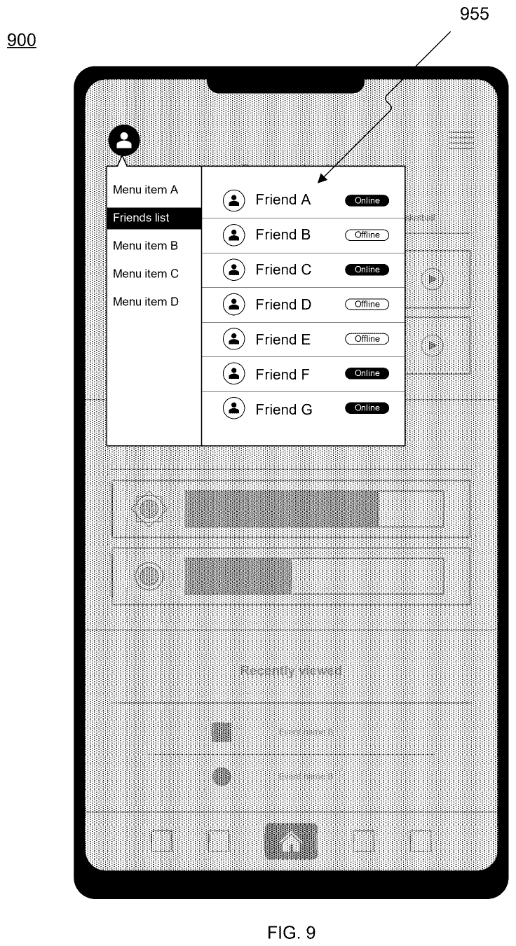

Referring now to FIG. 9, an exemplary competitive scoring platform 900 GUI for a portable device, according to some embodiments of the present disclosure, is illustrated. In some aspects, a user judge may connect with user judge friends 955 providing a type of social media platform. Connecting user judge friends 955 may allow for sharing of scores, such as illustrated in FIG. 4, which may allow for camaraderie and competition on the social media platform portion of the competitive scoring platform 900. In some implementations, user judge friends 955 may be able to simultaneously watch and score competitive events.

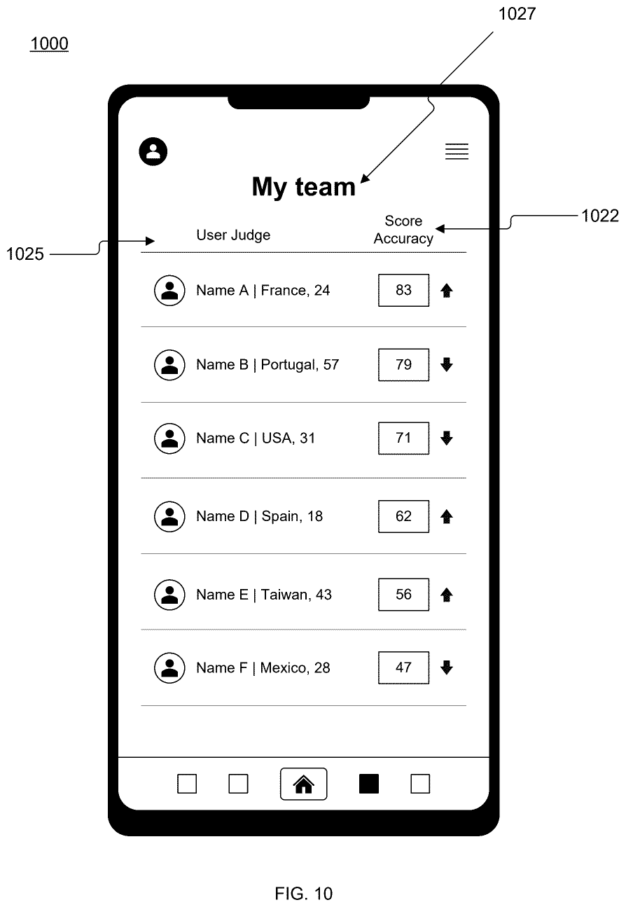

Referring now to FIG. 10, an exemplary competitive scoring platform 1000 GUI for a portable device, according to some embodiments of the present disclosure, is illustrated. In some aspects, a competitive scoring platform 1000 may allow for forming of user judge teams 1027 for fantasy competitions. User judges 1025 of a user judge team 1027 may be selected, drafted, or assigned, as non-limiting examples. User judge score accuracy 1022 may be presented in conjunction with the user judge team 1027. In some implementations, the user judge teams 1027 may compete against each other based on a particular competitive event, competitive event type, or other criteria.

### Conclusion

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

Reference in this specification to “one embodiment,” “an embodiment,” any other phrase mentioning the word “embodiment”, “aspect”, or “implementation” means that a particular feature, structure, or characteristic described in connection with the embodiment is included in at least one embodiment of the disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional.

Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

In a preferred embodiment of the present invention, functionality is implemented as software executing on a server that is in connection, via a network, with other portions of the system, including databases and external services. The server comprises a computer device capable of receiving input commands, processing data, and outputting the results for the user. Preferably, the server consists of RAM (memory), hard disk, network, central processing unit (CPU). It will be understood and appreciated by those of skill in the art that the server could be replaced with, or augmented by, any number of other computer device types or processing units, including but not limited to a desktop computer, laptop computer, mobile or tablet device, or the like. Similarly, the hard disk could be replaced with any number of computer storage devices, including flash drives, removable media storage devices (CDs, DVDs, etc.), or the like.

The network can consist of any network type, including but not limited to a local area network (LAN), wide area network (WAN), and/or the internet. The server can consist of any computing device or combination thereof, including but not limited to the computing devices described herein, such as a desktop computer, laptop computer, mobile or tablet device, as well as storage devices that may be connected to the network, such as hard drives, flash drives, removable media storage devices, or the like.

The storage devices (e.g., hard disk, another server, a NAS, or other devices known to persons of ordinary skill in the art), are intended to be nonvolatile, computer readable storage media to provide storage of computer-executable instructions, data structures, program modules, and other data for the mobile app, which are executed by CPU/processor (or the corresponding processor of such other components). There may be various components of the present invention that are stored or recorded on a hard disk or other like storage devices described above, which may be accessed and utilized by a web browser, mobile app, the server (over the network), or any of the peripheral devices described herein. One or more of the modules or steps of the present invention also may be stored or recorded on the server, and transmitted over the network, to be accessed and utilized by a web browser, a mobile app, or any other computing device that may be connected to one or more of the web browser, mobile app, the network, and/or the server.

References to a “database” or to “database table” are intended to encompass any system for storing data and any data structures therein, including relational database management systems and any tables therein, non-relational database management systems, document-oriented databases, NoSQL databases, or any other system for storing data.

Software and web or internet implementations of the present invention could be accomplished with standard programming techniques with logic to accomplish the various steps of the present invention described herein. It should also be noted that the terms “component,” “module,” or “step,” as may be used herein, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C #, Java, Cobol, assembler, PERL, Python, PHP, or the like, or macros using Excel or other similar or related applications with various algorithms being implemented with any combination of data structures, objects, processes, routines or other programming elements.

What is claimed is:

1. A competitive event scoring system including:
a cloud-based server configured to communicate with a plurality of user devices over a network;
a synchronization module executed by the cloud-based server and configured to:
establish a real-time data connection with an external broadcast system transmitting a live competitive event,
receive official judge score data from the external broadcast system, the official judge score data including a plurality of official scores assigned to a competitor in the live competitive event by a plurality of official judges, and
receive timestamp data from the external broadcast system indicating when the official judge score data becomes available;
a user interface module executed by the cloud-based server and configured to:
transmit competitive event video data to a user device of a user judge for display during the live competitive event,
receive user judge score data from the user device, the user judge score data including a user judge score assigned by the user judge to the competitor during the live competitive event, and
selectively transmit the official judge score data to the user device based on the timestamp data, wherein the official judge score data is obscured from display on the user device until receipt of the timestamp data indicating the official judge score data is available;
a score comparison module executed by the cloud-based server and configured to:
calculate a score differential value between the user judge score and the plurality of official scores,
generate a visual indicator based on the score differential value, the visual indicator representing a degree of accuracy of the user judge score relative to the plurality of official scores, and
transmit the visual indicator to the user device for display alongside the user judge score and the plurality of official scores; and
a storage module configured to store historical scoring data including:
a plurality of user judge scores from the user judge across multiple competitive events, and
a plurality of official score sets corresponding to the multiple competitive events,
wherein the score comparison module is further configured to calculate a cumulative accuracy metric for the user judge based on the historical scoring data and transmit the cumulative accuracy metric to the user device.

2. The system of claim 1, wherein the synchronization module is further configured to:
receive competitor statistics data from the external broadcast system, the competitor statistics data including at least one of: competitor name, competition group classification, performance difficulty metrics, or performance objective measurements; and
wherein the user interface module is further configured to transmit the competitor statistics data to the user device for display concurrently with the competitive event video data.

3. The system of claim 2, wherein the synchronization module includes an artificial intelligence image analysis component configured to:
process the competitive event video data to extract visual performance data from the live competitive event; and
generate the competitor statistics data based on the visual performance data, the competitor statistics data including at least one performance difficulty metric calculated from the visual performance data.

4. The system of claim 1, wherein the user interface module is further configured to:
block reception of user judge score data from the user device after receipt of the timestamp data indicating the official judge score data is available, thereby preventing the user judge from submitting the user judge score after the official judge score data becomes available.

5. The system of claim 1, wherein the score comparison module is further configured to:
discard a highest official score and a lowest official score from the plurality of official scores to generate a filtered set of official scores;
calculate the score differential value based on the user judge score and the filtered set of official scores; and
generate a comparison display element including the user judge score, the plurality of official scores, and a visual indication of which official scores were discarded.

6. The system of claim 1, further including:
a social platform module executed by the cloud-based server and configured to:
establish a user judge pairing between the user judge and at least one friend user judge,
receive friend user judge score data from a friend user device associated with the friend user judge, the friend user judge score data including a friend user judge score assigned to the competitor during the live competitive event,
calculate a friend score differential value between the friend user judge score and the plurality of official scores, and
transmit the friend user judge score and the friend score differential value to the user device for display alongside the user judge score and the score differential value.

7. The system of claim 1, further including:
a leaderboard module executed by the cloud-based server and configured to:
aggregate cumulative accuracy metrics for a plurality of user judges including the user judge,
rank the plurality of user judges based on the cumulative accuracy metrics to generate a ranked list,
identify at least one professional judge in training from the plurality of user judges based on a training status indicator associated with a user profile, and
transmit leaderboard data to the user device, the leaderboard data including the ranked list with visual differentiation of the at least one professional judge in training from casual user judges.

8. The system of claim 1, further including:
a training module executed by the cloud-based server and configured to:
provide access to a plurality of scoring courses, each scoring course including instructional content for scoring a particular type of competitive event,
track completion of scoring courses by the user judge, and
unlock access to advanced scoring courses based on the cumulative accuracy metric exceeding a predetermined threshold value.

9. A system for quantifying user scoring performance in a competitive event environment, the system including:
one or more processors; and
a non-transitory computer-readable medium storing instructions that, when executed by the one or more processors, cause the one or more processors to perform operations including:
generating a competitive scoring interface for display on a user device, wherein the competitive scoring interface displays a video stream of a competitor performing in a competitive event;
receiving, via the competitive scoring interface, a user judge score assigned to the competitor by a user judge;
receiving, from an external server associated with a live broadcasting entity, a set of actual judge scores assigned to the competitor by a panel of official judges;
executing a comparator algorithm to calculate a score accuracy metric for the user judge, wherein the score accuracy metric is a numerical value representing a deviation between the user judge score and the set of actual judge scores; and
generating a dynamic leaderboard interface that displays a ranking of a plurality of user judges, wherein the ranking is determined based on the calculated score accuracy metric associated with each of the plurality of user judges.

10. The system of claim 9, wherein the set of actual judge scores includes five distinct scores, and wherein computing the score accuracy metric includes:
identifying a highest score and a lowest score within the set of actual judge scores;
discarding the highest score and the lowest score to calculate an official final score; and
calculating the deviation between the user judge score and the official final score.

11. The system of claim 9, wherein the operations further include:
determining if the score accuracy metric meets a predefined training threshold; and
updating the dynamic leaderboard interface to display a visual indicator identifying the user judge as a professional judge in training based on the determination.

12. The system of claim 9, wherein the operations further include:
accessing a database of achievements, wherein each achievement is associated with a specific scoring milestone;
monitoring a history of user judge scores submitted by the user judge; and
unlocking a specific achievement on a profile of the user judge when the history of user judge scores satisfies the specific scoring milestone.

13. The system of claim 9, wherein the operations further include:
receiving, via the external server, an artificial intelligence (AI) image analysis of the competitor in the competitive event; and
displaying competitor statistics on the competitive scoring interface derived from the AI image analysis to validate the user judge score.

14. A computer-implemented method for managing unbiased user interaction with a live competitive event, the method including:
streaming, via a user interface on a client device, a broadcast of a competitive event featuring a competitor;
receiving, from a remote server, a data packet containing a set of actual judge scores assigned to the competitor by official judges, wherein the receiving occurs substantially simultaneously with the streaming of the competitive event;
rendering the user interface in a blind scoring state, wherein the blind scoring state includes:
a user input mechanism configured to accept a user score, and
a results region wherein the set of actual judge scores is maintained in a concealed format that prevents visual identification of the set of actual judge scores;
detecting an input of the user score via the user input mechanism; and
automatically transitioning the user interface from the blind scoring state to a revealed state in response to the detecting, wherein the revealed state renders the set of actual judge scores in a visible format within the results region.

15. The computer-implemented method of claim 14, wherein transitioning the user interface to the revealed state further includes: disabling the user input mechanism to prevent modification of the user score after the set of actual judge scores is rendered in the visible format.

16. The computer-implemented method of claim 14, wherein maintaining the set of actual judge scores in the concealed format includes applying a graphical obscuration layer over the results region, and wherein transitioning to the revealed state includes removing the graphical obscuration layer.

17. The computer-implemented method of claim 14, wherein the operations further include:
comparing the user score to the set of actual judge scores immediately upon transitioning to the revealed state; and
displaying a visual comparison graphic indicating a variance between the user score and the set of actual judge scores.

18. The computer-implemented method of claim 14, further including:
receiving a synchronization signal from the remote server indicating a conclusion of a performance by the competitor; and
enabling the user input mechanism only after receiving the synchronization signal.

19. The computer-implemented method of claim 14, further including:
receiving, from the remote server, a validated set of anticipated competitor statistics associated with the competitor; and
displaying the validated set of anticipated competitor statistics in the user interface prior to detecting the input of the user score to provide context for the user score.

20. The computer-implemented method of claim 19, wherein the validated set of anticipated competitor statistics includes one or more of: a wave height, a wave difficulty rating, or a maneuver difficulty rating.
